(19) United States
(12) Patent Application Publication
(10) Pub. No.: US 2013/0342845 A1
(43) Pub. Date: Dec. 26, 2013

(54) METHOD OF MULTISPECTRAL DECOMPOSITION FOR THE REMOVAL OF OUT-OF-BAND EFFECTS

(71) Applicant: Wei Chen, (US)

(72) Inventor: WEI CHEN, Potomac, MD (US)

(73) Assignee: Wei Chen, Potomac, MD (US)

(21) Appl. No.: 13/862,538

(22) Filed: Apr. 15, 2013

Related U.S. Application Data
(60) Provisional application No. 61/662,414, filed on Jun. 21, 2012.

(51) Int. Cl. G01J 3/02

(52) U.S. Cl. CPC G01J 3/0205
USPC 356/419

(57) ABSTRACT

A method of multispectral decomposition for the removal of out-of-band effects. A band of a multispectral radiance is measured using at least one optical filter, upon scanning a plurality of original radiances. A spectral range of an integral is partitioned between a maximum cut-off wavelength of the band and a minimum cut-off wavelength of the band into a plurality of sub-ranges. A multispectral radiance vector is generated from the measured band-averaged spectral radiances. The pre-calculated multispectral decomposition transform matrix corresponding to the optical filter and the measured multispectral radiance vector are matrix-multiplied to generate a band-averaged spectral radiances image vector representing a plurality of recovered band-averaged spectral radiances. The plurality of recovered band-averaged spectral radiances is outputted, for example to a display, thereby generating a plurality of recovered radiances free of out-of-band effects and which approximate the plurality of original radiances.

### CROSS-REFERENCE TO RELATED APPLICATIONS

The present application claims priority to U.S. Provisional Patent Application Ser. No. 61/662,414 filed 21 Jun. 2012.

### FIELD OF THE INVENTION

The invention relates generally to a method of image processing, and more particularly to a method of multispectral decomposition for the removal of out-of-band effects.

### BACKGROUND OF THE INVENTION

The Visible/Infrared Imaging Radiometer Suite (“VIIRS”), Flight Unit 1 (“FU1”), is onboard the first satellite platform managed by the Joint Polar Satellite System (“JPSS”) of NOAA and NASA. It collects scientific data from an altitude of approximately 830 km in 22 narrow bands located in the 0.4-12.5 micron range. The VIIRS instrument is, in many aspects, similar to the Moderate Resolution Imaging Spectroradiometer (“MODIS”) instruments currently on board the NASA Terra and Aqua Spacecrafts. A number of VIIRS bands are similar to those of the MODIS instrument but with small differences in band center positions and full widths at half maxima. The seven VIIRS VisNIR bands at a ‘moderate’ spatial resolution of 750 m in the wavelength interval between 0.4 and 0.9 micron, referred as M1-M7 and listed in Table 1, have important applications for global remote sensing of ocean, land, and atmosphere.

TABLE 1
VIIRS VisNIR band names, center wavelengths,
and full widths at half maximum (FWHM).

| VIIRS Band | λ (μm) | FWHM ((μm) |
|---|---|---|
| M1 | 0.412 | 0.020 |
| M2 | 0.445 | 0.018 |
| M3 | 0.488 | 0.020 |
| M4 | 0.555 | 0.020 |
| M5 | 0.672 | 0.020 |
| M6 | 0.746 | 0.015 |
| M7 | 0.865 | 0.039 |

These bands are known to suffer from out-of-band (“OOB”) responses, i.e., small amount of radiances far away from the center of a given band that pass through the filter and reach detectors in the focal plane.

FIG. 1 shows the normalized filter transmittance curves (at the peaks of filter functions) for the seven bands. The VIIRS filter data can be obtained freely from the website http://www.star.nesdis.noaa.giov/jpss/index.php. The M1 filter curve (red) peaks near 0.41 μm, but has non-negligible transmittances in the spectral region between 0.6 and 0.95 μm. A set of spectrally contiguous filter transmittance curves (normalized at the peak of the filter transmission) is shown in FIG. 1. These filter transmittance curves, such as M5, show significant OOB responses. The cause of the OOB responses is due to large angle scattering of radiances in the integrated filter assembly that overlies the VisNIR focal plane array.

A proper treatment of the OOB effects is necessary in order to obtain calibrated at-sensor radiance data (referred as Sensor Data Records, “SDRs”) from measurements with these bands, and subsequently to derive higher level data products (referred as the Environmental Data Records, “EDRs”). Significant errors will be introduced in the EDR data products, particularly in the EDRs over dark oceans, if the OOB effects are not well addressed.

The presence of OOB effects is not unique to the VIIRS instrument. The SeaWiFS (Sea-viewing Wide Field-of-view Sensor) satellite instrument also has OOB effects. Prior to the launch of the SeaWiFS instrument into space in 1997, Gordon developed a methodology for dealing with broad spectral bands and significant OOB responses. S. B. Hooker, W. E. Esaias, G. C. Feldman, W. W. Gregg, and C. R. McClain, An Overview of SeaWiFS and Ocean Color, BASA TM 104566, Vol. 1, S. B. Hooker and B. R. Firestone, eds. NASA Goddard Space Flight Center, Greenbelt, Md., 1992 And H. R. Gordon, Remote sensing of ocean color: a methodology for dealing with broad spectral bands and significant out-of-band response, Appl. Opt., 34, 8363-8374, 1995 are both incorporated herein by reference. Later on, a simple correction method, which is based on the Gordon methodology, to remove the spectral band effects of the SeaWiFS on the derived normalized water-leaving radiances and ocean near surface chlorophyll concentration, is developed and implemented in the operational SeaWiFS data processing system. It should be pointed out that the OOB corrections are not made to the SeaWiFS-measured top-of-the-atmosphere (“TOA”) radiances. Instead, the corrections are made to the derived ocean color data products. The SeaWiFS correction scheme works quite well over fairly clear ocean waters. However, the correction scheme is not applicable for SeaWiFS data products over turbid coastal waters or over land, where the shapes of the TOA spectral radiance distributions are very different from those over clear waters.

For the purpose of mitigating the OOB effect for VIIRS data acquired over clear ocean waters, researchers at Northrop Grumman followed the SeaWiFS data processing procedures and developed the concept of effective relative spectral response (“RSR”). M. Wang, B. A. Franz, R. A. Barnes, and C. R. McClain, Effects of spectral bandpass on SeaWiFS-retrieved near-surface optical properties of the ocean, Appl. Opt., 40, 343-348, 2001 is incorporated herein by reference. With this approach, the wavelength dependence of Rayleigh scattering is taken into consideration when generating look-up tables for retrieval algorithms. Because the spectral radiance curves of other types of surfaces, such as shallow waters, green vegetation, and clouds, are very different from that of the clear water spectrum, applicant determined that new approaches need to be developed to mitigate the OOB effect for VIIRS data measured over surfaces other than clear waters.

### BRIEF SUMMARY OF THE INVENTION

An embodiment of the invention includes a method. A band-averaged spectral radiance is measured using at least one optical filter, upon scanning a plurality of original radiances. A multispectral radiance vector is generated from the measured band-averaged spectral radiance. The multispectral radiance vector and a multispectral decomposition transform matrix corresponding to the optical filter are matrix-multiplied to generate an image vector of band-averaged spectral radiances representing a plurality of recovered band-averaged spectral radiances. The plurality of recovered band-averaged spectral radiances is outputted, for example to a display, thereby generating a plurality of recovered radiances free of out-of-band effects and which approximate the plurality of expected band-averaged spectral radiances. Optionally, the band of a multispectral radiance comprises a VIIRS band of a multispectral radiance or a SeaWiFS band of a multispectral radiance.

Optionally, each sub-range of the plurality of sub-ranges comprising a width, wherein the at least one optical filter comprises at least one filter transmittance function, wherein the plurality of sub-ranges comprises at least one partition parameter, and wherein the multispectral decomposition transform matrix is a function of at least one of the at least one filter transmittance function, the at least one partition parameter, and a position of the at least one optical filter.

Optionally, a spectral range of an integral is partitioned between a maximum cut-off wavelength of the band and a minimum cut-off wavelength of the band into a plurality of sub-ranges. Each sub-range of the plurality of sub-ranges consists of one narrow band signal. [0011] Optionally, the at least one optical filter comprises a number of multi-bands, the number of multi-bands being equal to a number of the plurality of sub-ranges.

Another embodiment of the invention includes a method called Multispectral Decomposition Transform (“MDT”). MDT can be used to correct/remove the OOB effects of VIIRS VisNIR bands and to recover the band-averaged spectral radiances from the measured radiances with OOB effects. A MDT matrix is, for example, derived based on the partition between a maximum cut-off wavelength of the band and a minimum cut-off wavelength of the band, and calculated from the laboratory-measured filter transmittance functions. The recovery of the band-averaged spectral radiances is performed through a matrix multiplication, i.e., the production between the MDT matrix and a measured multispectral vector.

In an illustrative embodiment of the invention, average errors after decomposition are reduced by more than one order of magnitude.

An embodiment of the invention removes OOB effects for VIIRS and/or SeaWiFS instruments and is measured-materials-independent.

### BRIEF DESCRIPTION OF THE DRAWINGS

FIG. 1A-1G are graphs of illustrative filter transmittance curves normalized at the peaks of filter functions of M1-M7 VIIRS VisNIR bands, respectively. [0016] FIG. 2 is a flow chart of an illustrative method embodiment of the instant invention.

FIG. 3 is a graph of illustrative filter transmittance curves normalized at the peaks of filter functions of F1-F8 SeaWiFS bands.

FIG. 4A is a graph of illustrative transmittance curves of SeaWiFS subsystem 1 formed by filter set {F1, F3, F5, F6, F7, and F8}.

FIG. 4B is a graph of illustrative transmittance curves of SeaWiFS subsystem 2 formed by filter set {F2, F4, F5, F6, F7, F8}.

### DETAILED DESCRIPTION OF THE INVENTION

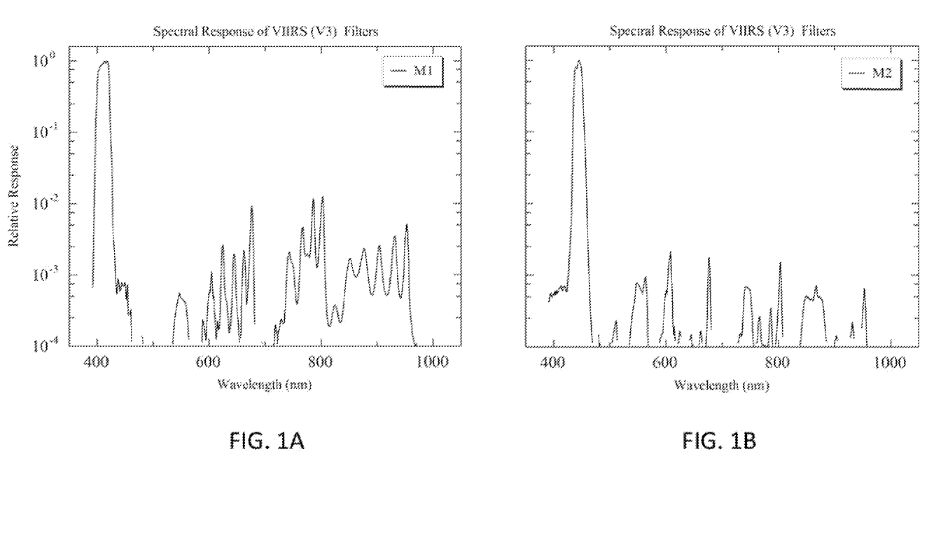

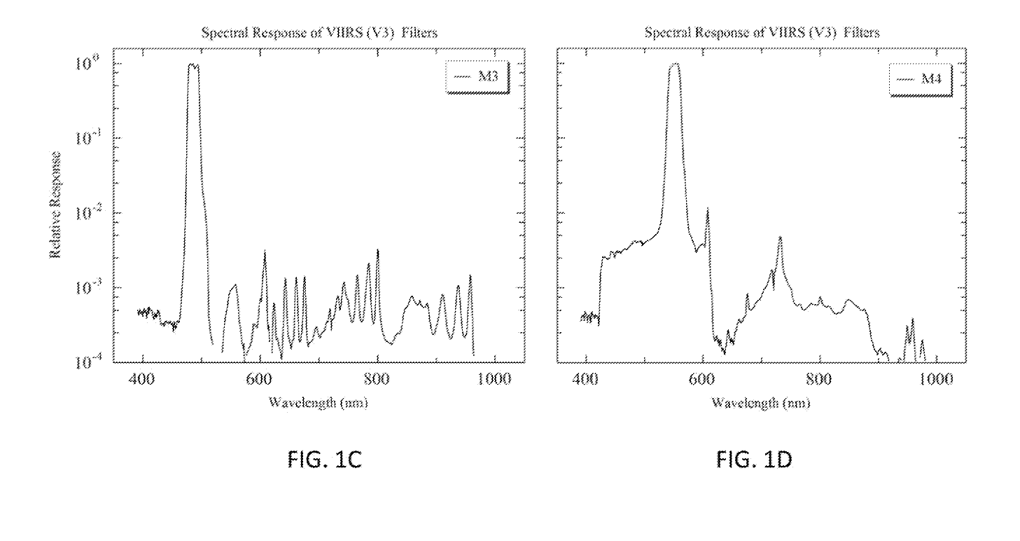

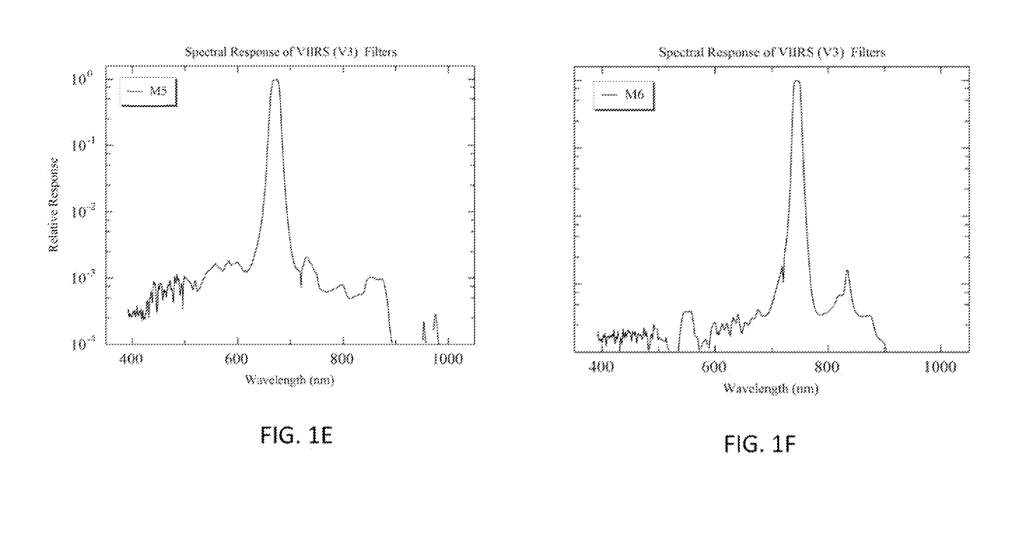

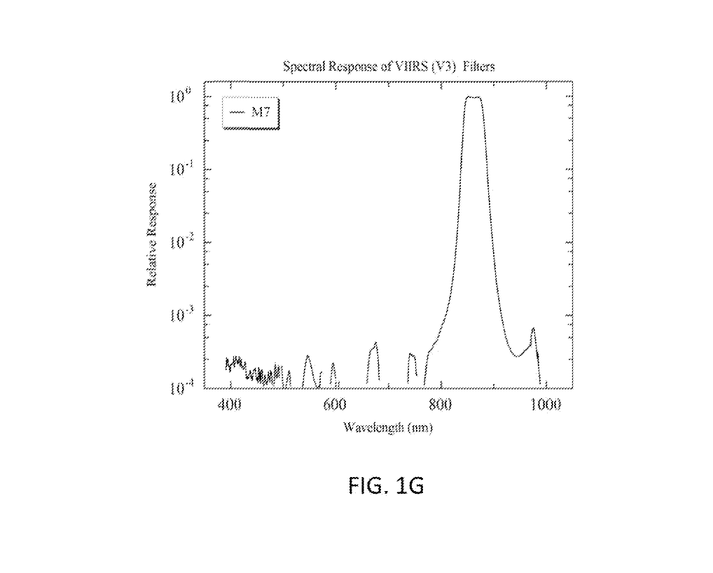

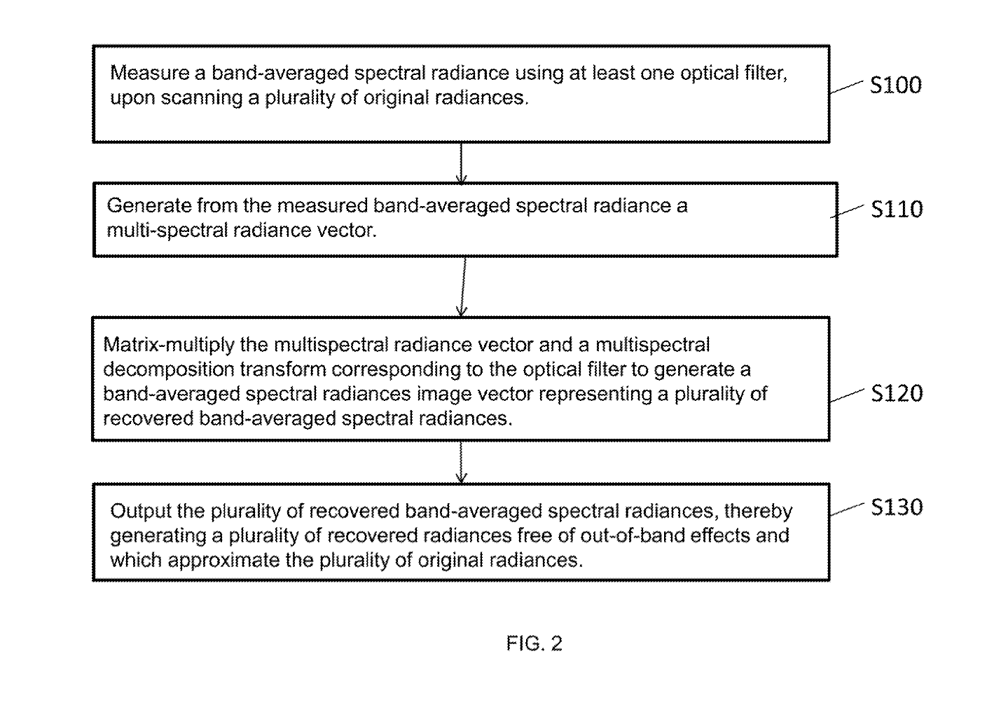

Referring to FIG. 1, applicant recognized that the OOB effect for a given band comes from a contiguous spectral range, instead of very limited narrow spectral intervals. Applicant recognized that because the OOB effects come from a contiguous spectral range, linear system theory could be advantageously used to deal with the issues of the OOB effect and to recover the band-averaged spectral radiances.

Referring to FIG. 2, an embodiment of the invention includes a method. In Step S100, a band-averaged spectral radiance is measured using at least one optical filter, upon scanning a plurality of original radiances. In Step S110, a multispectral radiance vector is generated from the measured band-averaged spectral radiance. In Step S120, the multispectral radiance vector and a multispectral decomposition transform (“MDT”) matrix corresponding to the optical filter is matrix-multiplied to generate an image vector of band-averaged spectral radiances representing a plurality of recovered band-averaged spectral radiances. In Step S130, the plurality of recovered band-averaged spectral radiances is outputted, for example to a display, storage, transmission, or to a printer, thereby generating a plurality of recovered radiances free of out-of-band effects and which approximate the plurality of original radiances. In this embodiment, the MDT matrix for the OOB correction is pre-calculated based on characteristics of the pre-measured filter transmittance functions, before an operation of the OOB correction.

Optionally, each sub-range of the plurality of sub-ranges comprising a width, wherein the at least one optical filter comprises at least one filter transmittance function, wherein the plurality of sub-ranges comprises at least one partition parameter, and wherein the multispectral decomposition transform matrix is a function of at least one of the at least one filter transmittance function, the at least one partition parameter, and a position of the at least one optical filter.

Optionally, each sub-range of the plurality of sub-ranges consists of one narrow band signal.

Optionally, the at least one optical filter comprises a number of multi-bands, the number of multi-bands being equal to a number of the plurality of sub-ranges.

In another embodiment of the invention, the steps according to FIG. 2 are executed in a different order. In this embodiment, the MDT matrix for the OOB correction is pre-calculated based on the characteristics of the filter transmittance functions. After the MDT matrix is obtained, the band-averaged spectral radiance can be recovered by a matrix production between the MDT matrix and a vector of the measured multispectral radiances. Advantageously, in this method, calculation of the MDT matrix need only be performed once, prior to any data collection by a VIIRS or SeaWiFS instrument. Then, whenever OOB correction is required for that instrument, the same MDT matrix is used for all datasets.

Another embodiment of the invention is described as follows Multiple Decomposition Transform Using Partition of a Linear Optical System

In general, a multispectral instrument such as VIIRS can be considered to be a system that accepts an input and produces an output in response. Such system is linear because the measured optical signal (ŝₖ=ŝₖ(i,j), where i and j are pixel indexes) from a sensor can be expressed by

ŝₖ=∫_{λ}_{ₘᵢₙ}^{λ}^{ₘₐₓ}hₖ(λ)s(λ)dλ (1)

where ŝₖ and s(λ) are measured (band-averaged spectral radiances with OOB effects) and original signals of a pixel, respectively, and hₖ(λ) is the normalized response (or transfer) function of a optical system (optical filters) with the wavelength λε[λₘᵢₙ, λₘₐₓ] as a variable. The above superposition integral expresses a relationship between original and measured signals with the optical filters.

If the range of the integral between the cut-off wavelengths λₘᵢₙ and λₘₐₓ is grouped into several sub-ranges, the sub-range partitions of the total integral are given by

$${\hat{s}}_{k} = {\sum }_{l = 1}^{n} {\int }_{{λ}_{min}^{( l )}}^{{λ}_{max}^{( l )}} {h}_{k} ( λ ) s ( λ ) d λ$$

where n is the number of bands, and λₘᵢₙ^{(l)} and λₘₐₓ^{(l)} are minimum and maximum wavelengths of the sub-range of the l^{th} filter. The total spectral range from λₘᵢₙ to λₘₐₓ is a summation of all sub-ranges, i.e.,

$$\{ \begin{matrix}{λ}_{max}^{( l - 1 )} = {λ}_{min}^{( l )} \\ {λ}_{min}^{( 1 )} = {λ}_{min} \\ {λ}_{max}^{( n )} = {λ}_{max}\end{matrix}$$

Using an average value of the response function between λₘᵢₙ^{(l)} and λₘₐₓ^{(l)} to replace the response function hₖ(λ) in the integral, we have

∫_{λ}_{ₘᵢₙ}_{^{(l)}}^{λ}^{ₘₐₓ}^{^{(l)}}hₖ(λ)s(λ)dλ≈ h̅ₖₗ∫_{λ}_{ₘᵢₙ}_{^{(l)}}^{λ}^{ₘₐₓ}^{^{(l)}}s(λ)dλ= h̅ₖₗΔλₗ s̅ₗ,

where Δλ₁=λₘₐₓ^{(l)}−λₘᵢₙ^{(l)}, the average of the response functions is given by

$${\overline{h}}_{kl} = \frac{1}{{Δλ}_{l}} {\int }_{{λ}_{min}^{( l )}}^{{λ}_{max}^{( l )}} {h}_{k} ( λ ) d λ , \qquad ( 2 )$$

and the narrowband signal that is an average of all signals within the sub-band Δλₗ is defined by

$${\overline{s}}_{l} = \frac{1}{{Δλ}_{l}} {\int }_{{λ}_{min}^{( l )}}^{{λ}_{max}^{( l )}} s ( λ ) d λ . \qquad ( 3 )$$

The measured k^{th} band-averaged spectral radiance is a summation of all recovered band-averaged spectral radiances and is given by

$${\hat{s}}_{k} = {\sum }_{l = 1}^{n} {\overline{h}}_{kl} {Δλ}_{l} {\overline{s}}_{l} . \qquad ( 4 )$$

The band-averaged spectral radiances s̅ₗ between λₘᵢₙ^{(l)} and λₘₐₓ^{(l)} defined in equation (3) are the recovered band-averaged spectral radiances. The measured signal with OOB effect is a superposition of all recovered band-averaged spectral radiances. The coefficient factors and parameters in equation (4) can be calculated using the response functions that are dependent on the characteristics of the filters of a particular instrument. Equation (4) is a mathematical expression of the physical effects of the OOB response. Our task is to resolve the recovered band-averaged spectral radiances from Eq. (4).

### The MDT Matrix

A vector form of multispectral images (sε{ŝ, s̅}) is defined by

$$s = ( \begin{matrix}{s}_{1} \\ {s}_{2} \\ … \\ {s}_{n}\end{matrix} ) . \qquad ( 5 )$$

Each component of the vector in (5) is a single band image. Substituting equation (4) into equation (5), we have

$$\hat{s} = ( \begin{matrix}{\sum }_{l = 1}^{n} {a}_{1 l} {\overline{s}}_{l} \\ {\sum }_{l = 1}^{n} {a}_{2 l} {\overline{s}}_{l} \\ … \\ {\sum }_{l = 1}^{n} {a}_{nl l} {\overline{s}}_{l}\end{matrix} ) = A \overline{s} ,$$

where aₖₗ= h̅ₖᵢΔλᵢ. It is clear that the recovered band-averaged spectral radiance image vector can be solved by

s̅=A⁻¹ŝ. (6)

For the purpose of this specification, the phrases “multispectral decomposition transform matrix” and “MDT matrix” are terms of art, wherein the inverse matrix A⁻¹ is called as the MDT matrix for recovering the band-averaged spectral radiances from the measured band-averaged spectral radiances with OOB effects. An illustrative method of deriving the MDT matrix generally is described above in paragraphs [0027]-[0030]. Illustrative MDT matrices for VIIRS and SeaWiFS are provided below to show specific, exemplary instances of the MDT matrix. All elements of the matrix A depend on the response functions of the filters, sub-band widths, and positions of the filters. Therefore, the spectral transform matrix can be fully determined by the characteristics of the filters.

### The MDT Matrix for VIIRS

Using equation (6), the recovered band-averaged spectral radiances can be calculated by the MDT matrix and the measured multi-band image vector (with OOB effects). In this section, we describe the numerical computations of the MDT matrix for the VIIRS VisNIR filters.

The seven band filter transmittance functions as shown by way of illustration in FIG. 1 indicate that the filter widths and positions are not uniform. Based on careful analysis of the shapes of these filter functions, a non-uniform partition is observed. The resulting wavelength ranges and cutting off positions for the seven bands are shown in Table 2.

TABLE 2
Wavelength ranges of subbands for the VIIRS instrument filters
as measured from the filter transmittance curves in Figure 1.

| VIIRS Band | λₘᵢₙ_{⁽¹⁾} (μm) | λₘₐₓ_{⁽⁷⁾} ((μM) |
|---|---|---|
| M1 | 0.391 | 0.429 |
| M2 | 0.429 | 0.463 |
| M3 | 0.463 | 0.522 |
| M4 | 0.522 | 0.596 |
| M5 | 0.596 | 0.724 |
| M6 | 0.724 | 0.782 |
| M7 | 0.782 | 1.001 |

The wavelengths of the sub-ranges λₘᵢₙ^{(l)} of the filter 1 and λₘₐₓ^{(l)} of the filter 7 need to extent to lowest and highest boundaries in the total cut-off wavelength range. The transmittance function for filter 4 shown in FIG. 1 has more out of band response than the other filters. A narrower wavelength range that covers only the portion of the central transmittance region for this particular filter is selected.

The transmittance functions of the VIIRS filters in FIG. 1 are normalized at peak. All response functions defined in equation (1) and (2) must be normalized using the transmittance functions of the VIIRS filters in FIG. 1 before the computation for the MDT matrix. The normalized response functions hₖ(λ) is given by

$${h}_{k} ( λ ) = \frac{{H}_{k} ( λ )}{{\int }_{{λ}_{min}}^{{λ}_{max}} {H}_{k} ( λ ) d λ} ,$$

where Hₖ(λ) are the transmittance functions of the VIIRS filters in FIG. 1 between the total wavelength range from λₘᵢₙ to λₘₐₓ.

The MDT matrix A⁻¹ for the VIIRS instrument based on the wavelength partition in Table 2 and the transmittance functions of the filters in FIG. 1 has been computed through a mathematical inversion by Gauss-Jordan elimination, and is given by

$$( \begin{matrix}1.0286 & - 1.32656 \times {10}^{- 3} & - 9.64811 \times {10}^{5} & - 6.26276 \times {10}^{- 4} & - 5.26322 \times {10}^{- 3} & - 4.13883 \times {10}^{- 3} & - 1.68423 \times {10}^{- 2} \\ - 1.86106 \times {10}^{- 3} & 1.00977 & - 4.52782 \times {10}^{- 4} & - 1.48041 \times {10}^{- 3} & - 2.13087 \times {10}^{- 3} & - 1.01843 \times {10}^{- 3} & - 2.82691 \times {10}^{- 3} \\ - 9.56242 \times {10}^{- 4} & - 5.95628 \times {10}^{- 4} & 1.01368 & - 1.48632 \times {10}^{- 3} & - 3.24938 \times {10}^{- 3} & - 2.04484 \times {10}^{- 3} & - 5.34673 \times {10}^{- 3} \\ - 1.1785 \times {10}^{- 3} & - 4.7093 \times {10}^{- 3} & - 1.20242 \times {10}^{- 2} & 1.0327 & - 7.46696 \times {10}^{- 3} & - 3.84353 \times {10}^{- 3} & - 3.47807 \times {10}^{- 3} \\ - 5.78424 \times {10}^{- 4} & - 1.04277 \times {10}^{- 3} & - 2.35638 \times {10}^{- 3} & - 5.14373 \times {10}^{- 3} & 1.01684 & - 3.31716 \times {10}^{- 3} & - 4.40333 \times {10}^{- 3} \\ - 4.38729 \times {10}^{- 4} & - 4.00096 \times {10}^{- 4} & - 6.33179 \times {10}^{- 4} & - 1.00671 \times {10}^{- 3} & - 3.99606 \times {10}^{- 3} & 1.01061 & - 4.13453 \times {10}^{- 3} \\ - 2.23718 \times {10}^{- 4} & - 1.35422 \times {10}^{- 4} & - 1.89362 \times {10}^{- 4} & - 2.13841 \times {10}^{- 4} & - 3.02904 \times {10}^{- 4} & - 2.41025 \times {10}^{- 4} & 1.00131\end{matrix} ) .$$

All main diagonal elements in the MDT matrix for the VIIRS instrument are greater than and nearly equal to one. Almost all non-diagonal elements for the OOB corrections are negative because the measured signal with OOB effect for a particular band is a superposition of all other band signals. A decomposed signal must be extracted from the measured signals with OOB effects. The correction amount is dependent on the characteristics of the filters. The fourth row with larger correction amounts in the MDT matrix is corresponding to a poor filter such as filter 4 as shown in FIG. 1.

It is noted that the summation of all column elements in the MDT matrix is equal to unity, i.e.,

$${\sum }_{l = 1}^{n} {( {A}^{- 1} )}_{kl} = 1.$$

Therefore, the correction coefficients in the MDT matrix for each band are also normalized. To avoid overflow results for the multiplication between the MDT matrix and the spectral image vector, a data type with double precision is used for the computation.

### The MDT Matrix for SeaWiFS

The SeaWiFS instrument is designed to measure earth-exiting radiance. The SeaWiFS spectral bands cover the range from 0.38 to 1.15 μm for all eight VisNIR (visible near infrared) bands, with nominal band centers as shown below in Table 3 (first two columns).

TABLE 3
SEA WiFS VisNIR band names, positions,
and ranges of subbands.

| SeaWiFS | | | |
|---|---|---|---|
| Band | λ (μm) | λₘᵢₙ (μm) | λₘₐₓ (μm) |
| F1 | 0.412 | 0.380 | 0.457 |
| F2 | 0.443 | 0.380 | 0.469 |
| F3 | 0.490 | 0.457 | 0.526 |
| F4 | 0.510 | 0.469 | 0.532 |
| F5 | 0.555 | {0.526, 0.532} | 0.620 |
| F6 | 0.670 | 0.620 | 0.707 |
| F7 | 0.765 | 0.707 | 0.822 |
| F8 | 0.865 | 0.822 | 1.100 |

The SeaWiFS multispectral bands are known to exhibit significant OOB response.

The average spectral bandwidth for the k^{th} band filter without the OOB effect is usually defined by

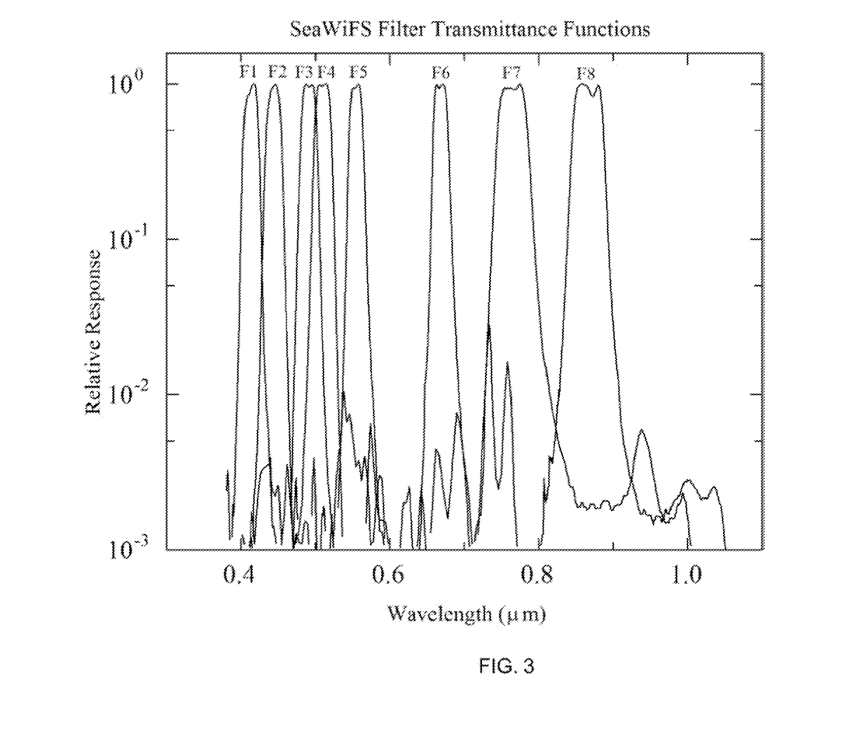

Hₖ({ₘᵢₙ^{(k)},λₘₐₓ^{(k)}})=0.01×max[Hₖ(λ)], (7)

where Hₖ(λ) are the filter transmittance functions normalized at the peaks, that is, the band extends to the 1% level of the filter's response. To recover the band-averaged spectral radiances by the MDT method, the full cut-off wavelength range is partitioned into N subbands in which each sub-bandwidth should cover and be greater than or equal to a spectral bandwidth defined in (7). The SeaWiFS transmittance functions, shown by way of illustration in FIG. 3, indicate that the first four filters are severely overlapped. The MDT sub-bandwidths for these bands may be less than the average bandwidths defined in (7) and the conditions

$$\{ \begin{matrix}{λ}_{max}^{( l - 1 )} = {λ}_{min}^{( l )} \\ {λ}_{min}^{( 1 )} = {λ}_{min} \\ {λ}_{max}^{( n )} = {λ}_{max}\end{matrix}$$

may not be satisfied.

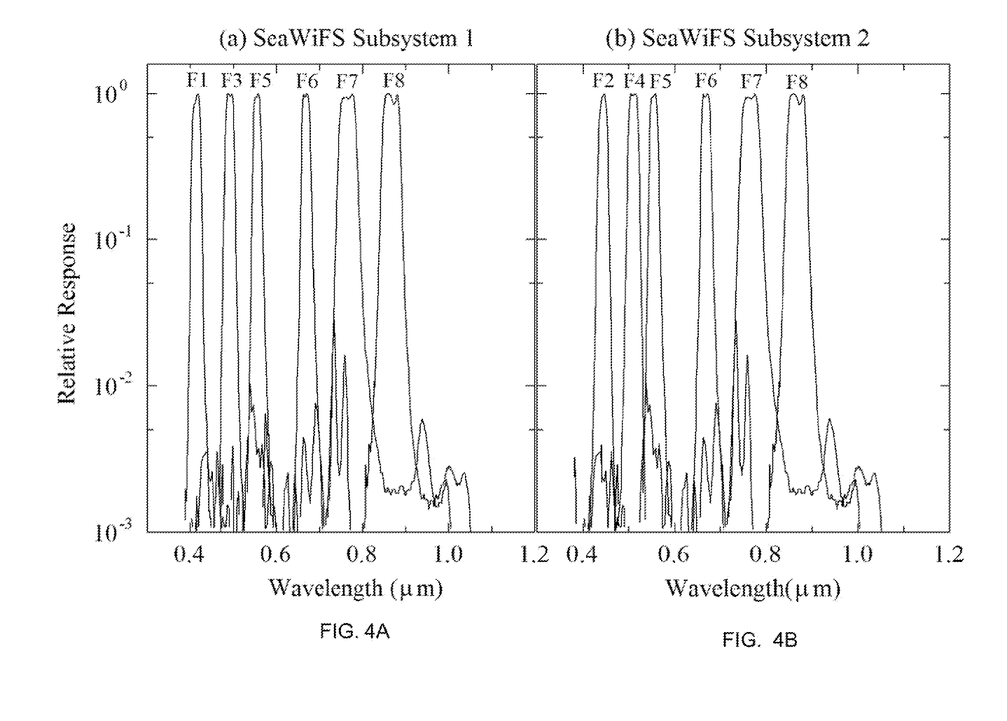

To solve the issue of the overlapped filters for the SeaWiFS instrument, all eight spectral band system is sampled into two subsystems in which each subsystem has six no overlapped filter transmittance functions with filters {1, 3, 5, 6 7, 8} and {2, 4, 5, 6, 7, 8}, respectively, as shown by way of illustration in FIGS. 4A and 4B.

The OOB corrected signals in (5) for each subsystem are given by

s̅_{{1,2}}=A_{{1,2}}⁻¹ŝ_{{1,2}},

where the list {1, 2} is a subsystem index, and A_{{1,2}} are two matrixes for the two sets of SeaWiFS filters {1, 3, 5, 6, 7, 8} and {2, 4, 5, 6, 7, 8}, respectively. The subband wavelengths for computing the matrix A_{{1, 2}} are listed in Table 3.

The SeaWiFS transmittance functions shown in FIGS. 4A and 4B are normalized at peak. All response functions defined in equation (1) must be normalized using the transmittance functions of the SeaWiFS filters shown in FIGS. 4A and 4B before the computation for the MDT matrix. The normalized response functions hₖ(λ) are given by

$${h}_{k} ( λ ) = \frac{{H}_{k} ( λ )}{{\int }_{{λ}_{min}}^{{λ}_{max}} {H}_{k} ( λ ) d λ} ,$$

where Hₖ(λ) are the transmittance functions of the SeaWiFS filters shown in FIGS. 4A and 4B.

The two sampled MDT matrixes A⁻¹_{{1,2}} for the SeaWiFS instrument based on the wavelength partition in Table 3 and the transmittance functions of the filters shown in FIGS. 4A and 4B have been computed through a mathematical inversion by Gauss-Jordan elimination, respectively. A single MDT matrix that is combined from the two sampled MDT matrixes is given by

$$( \begin{matrix}1.00237 & 0 & - 2.20636 \times {10}^{- 3} & 0 & - 4.63809 \times {10}^{- 5} & - 1.13876 \times {10}^{- 4} & - 6.0804 \times {10}^{- 6} & - 1.97994 \times {10}^{- 6} \\ 0 & 1.0007 & 0 & - 3.59162 \times {10}^{- 4} & - 3.33987 \times {10}^{- 4} & - 7.906446 \times {10}^{- 6} & - 1.95142 \times {10}^{- 6} & - 1.85527 \times {10}^{- 6} \\ - 7.06568 \times {10}^{- 4} & 0 & 1.00563 & 0 & - 4.54599 \times {10}^{- 3} & - 1.30773 \times {10}^{- 5} & - 1.11946 \times {10}^{- 5} & - 3.53573 \times {10}^{- 4} \\ 0 & - 1.55306 \times {10}^{- 3} & 0 & 1.00337 & - 1.43265 \times {10}^{- 3} & - 4.34896 \times {10}^{- 5} & - 2.20582 \times {10}^{- 5} & - 3.18183 \times {10}^{- 4} \\ 0 & - 8.18046 \times {10}^{- 3} & 0 & - 1.13866 \times {10}^{- 3} & 1.02168 & - 1.09881 \times {10}^{- 2} & - 7.9513 \times {10}^{- 4} & - 5.6966 \times {10}^{- 4} \\ 0 & - 1.16122 \times {10}^{- 3} & 0 & - 1.59102 \times {10}^{- 3} & - 1.23495 \times {10}^{- 3} & 1.00535 & - 8.66901 \times {10}^{- 4} & - 4.92327 \times {10}^{- 4} \\ 0 & - 2.65926 \times {10}^{- 4} & 0 & - 4.17089 \times {10}^{- 6} & - 2.2897 \times {10}^{- 4} & - 1.26569 \times {10}^{- 3} & 1.01427 & - 1.25089 \times {10}^{- 2} \\ 0 & - 5.07174 \times {10}^{- 4} & 0 & - 6.84919 \times {10}^{- 4} & - 6.22431 \times {10}^{- 3} & - 6.07481 \times {10}^{- 5} & - 1.23029 \times {10}^{- 2} & 1.01966\end{matrix} ) .$$

where the first and third bands are corrected by the bands {1, 3, 5, 6, 7, 8} and rest bands are corrected by the bands {2, 4, 5, 6, 7, 8}.

Optionally, VIIRS and/or SeaWiFS filter functions obtained from pre-launch laboratory measurements of the high altitude aircraft and/or satellite platforms.

An embodiment of the invention comprises a computer program for processing outputs of the optical fibers to detect acoustic phase changes, which computer program embodies the functions, filters, or subsystems described herein. However, it should be apparent that there could be many different ways of implementing the invention in computer programming, and the invention should not be construed as limited to any one set of computer program instructions. Further, a skilled programmer would be able to write such a computer program to implement an exemplary embodiment based on the appended diagrams and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

One of ordinary skill in the art will recognize that the methods, systems, and control laws discussed above with respect to acoustic phase detection may be implemented in software as software modules or instructions, in hardware (e.g., a standard field-programmable gate array (“FPGA”) or a standard application-specific integrated circuit (“ASIC”), or in a combination of software and hardware. The methods, systems, and control laws described herein may be implemented on many different types of processing devices by program code comprising program instructions that are executable by one or more processors. The software program instructions may include source code, object code, machine code, or any other stored data that is operable to cause a processing system to perform methods described herein.

The methods, systems, and control laws may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and/or data structures described herein may be connected directly or indirectly to each other in order to allow the flow of data needed for their operations. It is also noted that software instructions or a module can be implemented for example as a subroutine unit or code, or as a software function unit of code, or as an object (as in an object-oriented paradigm), or as an applet, or in a computer script language, or as another type of computer code or firmware. The software components and/or functionality may be located on a single device or distributed across multiple devices depending upon the situation at hand.

Systems and methods disclosed herein may use data signals conveyed using networks (e.g., local area network, wide area network, internet, etc.), fiber optic medium, carrier waves, wireless networks, etc. for communication with one or more data processing devices. The data signals can carry any or all of the data disclosed herein that is provided to or from a device.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

These and other implementations are within the scope of the following claims.

What is claimed as new and desired to be protected by Letters Patent of the United States is:

1. A method comprising:
measuring a band-averaged spectral radiance using at least one optical filter, upon scanning a plurality of original radiances;
generating from the measured band-averaged spectral radiance a multispectral radiance vector;
matrix-multiplying the multispectral radiance vector and a multispectral decomposition transform matrix corresponding to the optical filter to generate a band-averaged spectral radiances image vector representing a plurality of recovered band-averaged spectral radiances; and
outputting the plurality of recovered band-averaged spectral radiances, thereby generating a plurality of recovered radiances free of out-of-band effects and which approximate the plurality of original radiances.

2. The method according to claim 1, wherein each sub-range of the plurality of sub-ranges comprising a width,
wherein the at least one optical filter comprises at least one filter transmittance function,
wherein the plurality of sub-ranges comprises at least one partition parameter, and
wherein the multispectral decomposition transform matrix is a function of at least one of the at least one filter transmittance function, the at least one partition parameter, and a position of the at least one optical filter.

3. The method according to claim 1, wherein the at least one optical filter comprises a number of multi-bands, the number of multi-bands being equal to a number of the plurality of sub-ranges.

4. The method according to claim 1, wherein the measured band-averaged spectral radiance comprises a measured optical signal with out-of-band effects ŝₖ=ŝₖ(i,j), where i and j are pixel indexes,
wherein a measured kth band-averaged spectral radiance is represented as
$${\hat{s}}_{k} = {\sum }_{l = 1}^{n} {\overline{h}}_{kl} {Δλ}_{l} {\overline{s}}_{l} ,$$
wherein n is a number of bands,
h̅ₖₗ is an average of a plurality of filter response functions,
Δλₗ is a width of partitioned sub-band, and
s̅ₗ is a recovered lth band-averaged spectral radiance that is an average of all signals within the sub-band Δλₗ.

5. The method according to claim 1, wherein the band-averaged spectral radiance vector is represented as
$$s = ( \begin{matrix}{s}_{1} \\ {s}_{2} \\ … \\ {s}_{n}\end{matrix} ) ,$$
wherein each component sₖ of the band-averaged spectral radiance vector is a single band image.

6. The method according to claim 1, wherein the band-averaged spectral radiance image vector is represented as ē=A⁻¹ŝ,
wherein A⁻¹ is the multispectral decomposition matrix and ŝ is the measured band-averaged spectral radiance vector.

7. The method according to claim 1, wherein the band-averaged spectral radiance comprises one of a VIIRS band-averaged spectral radiance and a SeaWiFS band-averaged spectral radiance.
